(19) United States
(12) Patent Application Publication
(10) Pub. No.: US 2018/0039519 A1
(43) Pub. Date: Feb. 8, 2018

(54) SYSTEMS AND METHODS FOR MANAGING PROCESSING LOAD

(71) Applicant: QUALCOMM Incorporated, San Diego, CA (US)

(72) Inventors: Akash Kumar, Hyderabad (IN); Ankit Maheshwari, Hyderabad (IN); Shruti Agrawal, Hyderabad (IN)

(21) Appl. No.: 15/231,535

(22) Filed: Aug. 8, 2016

(51) Int. Cl. G06F 9/50; G06F 9/48; G06F 9/46

(52) U.S. Cl. CPC G06F 9/5027; G06F 9/5044; G06F 9/5094; G06F 9/461; G06F 9/4812; G06F 2209/509; G06F 2209/5022

(57) ABSTRACT

A method for managing processing load by an electronic device is described. The method includes determining to offload a task being executed on the electronic device. The method also includes communicating with a peer device. The method further includes determining that the peer device is capable of executing the task based on the communication. The method additionally includes offloading the task to the peer device. The method also includes receiving an output of the task. The output is generated while the peer device is executing the task.

### FIELD OF DISCLOSURE

The present disclosure relates generally to electronic devices. More specifically, the present disclosure relates to systems and methods for managing processing load.

### BACKGROUND

Some electronic devices (e.g., computers, laptop computers, cellular phones, smartphones, tablet devices, game consoles, televisions, automobiles, appliances, cameras, set-top boxes, etc.) communicate with other devices. For example, a smartphone may access a local area network (LAN) and/or a wide area network (WAN) (e.g., the Internet). Electronic devices may send data to and/or receive data from one or more devices.

As technology improves, more devices are being used to communicate with other devices. Additionally, many devices are communicating with other devices more often. For example, many people access the Internet for work and recreational purposes many times throughout the day.

As technology progresses, greater demands are being placed on device processing. In particular, instructions with greater processing complexity are being executed on increasing amounts of data in many cases. As can be observed from this discussion, systems and methods that improve processing may be beneficial.

### SUMMARY

A method for managing processing load by an electronic device is described. The method includes determining to offload a task being executed on the electronic device. The method also includes communicating with a peer device. The method further includes determining that the peer device is capable of executing the task based on the communication. The method additionally includes offloading the task to the peer device. The method also includes receiving an output of the task. The output is generated while the peer device is executing the task. Determining that the peer device is capable of executing the task may include determining that the peer device has available processing capacity to execute the task.

Offloading the task may include stopping execution of the task on the electronic device. Offloading the task may include sending an instruction to the peer device to cause the peer device to execute the task.

Determining to offload the task may include determining that the processing load of the electronic device has exceeded a threshold. Determining to offload the task may include determining that the processing load in Million Instructions Per Second (MIPS) has exceeded a MIPS threshold. Determining to offload the task may be based on a thermal condition on the electronic device.

The method may include determining, after the task has been offloaded, to restore the task to the electronic device. The method may also include instructing the peer device to stop executing the task. The method may additionally include resuming executing the task on the electronic device.

The method may include utilizing, by one or more applications on the electronic device, the output of the task. The method may include dynamically initiating a peer-to-peer link with the peer device in response to determining to seek the peer-to-peer relationship with one or more potential peer devices based on the processing load.

An electronic device for managing processing load is also described. The electronic device includes a processor configured to determine to offload a task being executed on the electronic device. The processor is also configured to communicate with a peer device. The processor is further configured to determine that the peer device is capable of executing the task based on the communication. The processor is additionally configured to offload the task to the peer device. The processor is also configured to receive an output of the task. The output is generated while the peer device is executing the task.

A computer-program product for managing processing load is also described. The computer-program product includes a non-transitory tangible computer-readable medium with instructions. The instructions include code for causing an electronic device to determine to offload a task being executed on the electronic device. The instructions also include code for causing the electronic device to communicate with a peer device. The instructions further include code for causing the electronic device to determine that the peer device is capable of executing the task based on the communication. The instructions additionally include code for causing the electronic device to offload the task to the peer device. The instructions also include code for causing the electronic device to receive an output of the task. The output is generated while the peer device is executing the task.

An apparatus for managing processing load is also described. The apparatus includes means for determining to offload a task being executed on the electronic device. The apparatus also includes means for communicating with a peer device. The apparatus further includes means for determining that the peer device is capable of executing the task based on the communication. The apparatus additionally includes means for offloading the task to the peer device. The apparatus also includes means for receiving an output of the task. The output is generated while the peer device is executing the task.

### BRIEF DESCRIPTION OF THE DRAWINGS

FIG. 1 is a block diagram illustrating one example of an electronic device in which systems and methods for managing processing load may be implemented;

FIG. 2 is a flow diagram illustrating one configuration of a method for managing processing load;

FIG. 3 is a flow diagram illustrating a more specific configuration of a method for managing processing load;

FIG. 4 is a flow diagram illustrating another more specific configuration of a method for managing processing load;

FIG. 5 is a flow diagram illustrating yet another more specific configuration of a method for managing processing load;

FIG. 6 is a flow diagram illustrating yet another more specific configuration of a method for managing processing load;

FIG. 7 is a flow diagram illustrating yet another more specific configuration of a method for managing processing load;

FIG. 8 is a flow diagram illustrating one configuration of a method for performing one or more offloaded tasks;

FIG. 9 is a thread diagram illustrating an example of offloading one or more tasks to a peer device in accordance with the systems and methods disclosed herein; and

FIG. 10 illustrates certain components that may be included within an electronic device configured to implement various configurations of the systems and methods disclosed herein.

### DETAILED DESCRIPTION

The systems and methods disclosed herein relate to managing processing load. For example, some configurations of the systems and methods disclosed herein may relate to intelligent inter-device million instructions per second (MIPS) management.

Computation complexity has significantly increased in many devices (e.g., computers, smartphone, Internet of Everything (IoE) device, Internet of Things (IoT) device, etc.) in general due to the time critical nature of applications and/or multiple tasks to be performed in parallel. Adding several new features to be supported concurrently further adds to the complexity as well. These factors have resulted in an increase to the processing load (e.g., MIPS requirements on the processor).

The combination of simultaneously running tasks imposes an overall restriction in terms of total processing load (e.g., MIPS) that can be handled by one or more processors on a device. This can lead to unstable system behavior with not all scheduled tasks getting executed successfully at all times. For example, consider an IoE or a home network scenario where multiple devices are linked to each other. In case the processor (e.g., CPU) load reaches and/or exceeds a certain threshold, some approaches may close some of the applications or put the applications in a lower usage mode. These approaches may not be optimum, possibly resulting in some of the user applications becoming non-responsive or getting closed. Ensuring system stability and reliable performance may be a beneficial feature for many devices.

To overcome one or more of the aforementioned problems, some configurations of the systems and methods disclosed herein may utilize a load-sharing approach between two or more connected devices. For example, some configurations of the systems and methods disclosed herein may provide a mechanism where the processing load (e.g., central processing unit (CPU) load and/or MIPS requirements) may be shared between two or more linked devices. In some approaches, a device with a processing load (e.g., threshold load, threshold MIPS usage, higher MIPS usage, etc.) may offload one or more activities (e.g., tasks, applications, etc.) to one or more linked devices (e.g., paired devices).

Examples of use cases where the load sharing can be implemented are given as follows. Assume that device A is operating under a MIPS-limited scenario. Device B may be paired with device A and may or may not be performing similar activities as device A. Device B has better CPU usage at that time (e.g., available processor capacity, lower processing load, available MIPS capacity, etc.).

In one example, assume that a global positioning system (GPS) application is one of the activities running on device A. Device A may communicate with device B to get information regarding the current CPU usage and/or available MIPS on device B. Device A may decide the activity (e.g., application, task, etc.) that needs to be off-loaded (the GPS application in one example). Device A may stop running the particular activity, which may improve the CPU usage (e.g., reduce the processing load). Device B may start the activity (e.g., application, if already not running) and may provide the final output to device A using the paired link.

The activity (e.g., application(s), task(s), etc.) to be offloaded may be user configurable and/or decided dynamically based on the sharing mechanism. While a GPS application is one example, the systems and methods disclosed herein may be applied to multiple user and/or device activities to reduce and/or overcome any MIPS limited scenario on a particular device. Other scenarios may occur. For example, a device may not necessarily be MIPS limited, but may be suffering from other effects (e.g., thermal effects, etc.). As illustrated by this discussion, some configurations of the systems and methods disclosed herein may provide a processing (e.g., MIPS) sharing mechanism to help ensure that a device handles all needed applications reliably (even in a MIPS limited concurrency scenario, for example).

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

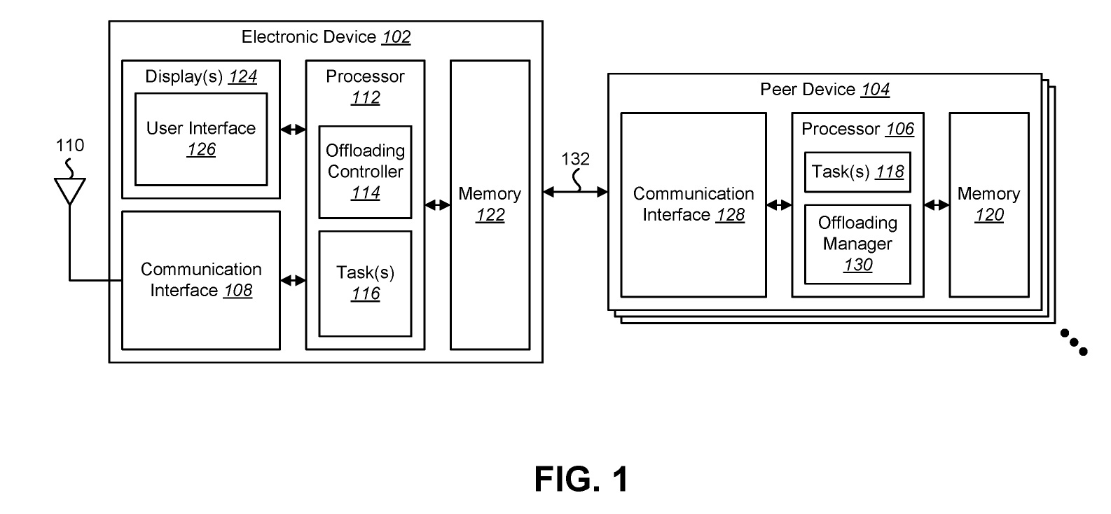

FIG. 1 is a block diagram illustrating one example of an electronic device 102 in which systems and methods for managing processing load may be implemented. Examples of the electronic device 102 include computers (e.g., desktop computers, laptop computers, etc.), cellular phones, smartphones, tablet devices, media players, televisions, vehicles, cameras, virtual reality devices (e.g., headsets), augmented reality devices (e.g., headsets), mixed reality devices (e.g., headsets), gaming consoles, personal digital assistants (PDAs), set-top boxes, appliances, etc. The electronic device 102 may include one or more components or elements. One or more of the components or elements may be implemented in hardware (e.g., circuitry) or a combination of hardware and software and/or firmware (e.g., a processor with instructions).

In some configurations, the electronic device 102 may include a processor 112, a memory 122, one or more displays 124, and/or a communication interface 108. The processor 112 may be coupled to (e.g., in electronic communication with) the memory 122, display 124, and/or communication interface 108. The processor 112 may be a general-purpose single- or multi-chip microprocessor (e.g., an ARM), a special-purpose microprocessor (e.g., a digital signal processor (DSP)), a microcontroller, a programmable gate array, etc. The processor 112 may be referred to as a central processing unit (CPU). Although just a single processor 112 is shown in the electronic device 102, in an alternative configuration, a combination of processors (e.g., an ISP and an application processor, an ARM and a DSP, etc.) could be used. The processor 112 may be configured to implement one or more of the methods disclosed herein.

The memory 122 may store instructions for performing operations by the processor 112. The memory 122 may be any electronic component capable of storing electronic information. The memory 122 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data and/or instructions may be stored in the memory 122. The instructions may be executable by the processor 112 to implement one or more of the methods described herein. Executing the instructions may involve the use of the data that is stored in the memory 122. When the processor 112 executes the instructions, various portions of the instructions may be loaded onto the processor 112, and various pieces of data may be loaded onto the processor 112.

The processor 112 may access (e.g., read from and/or write to) the memory 122. Examples of instructions and/or data that may be stored by the memory 122 may include one or more task outputs, offloading controller 114 instructions, and/or task 116 instructions, etc.

In some configurations, the electronic device 102 may present a user interface 126 on the display 124. For example, the user interface 126 may enable a user to interact with the electronic device 102. For example, the user interface 126 may receive a touch, a mouse click, a gesture and/or some other input indicates a command or request.

The display(s) 124 may be integrated into the electronic device 102 and/or may be coupled to the electronic device 102. For example, the electronic device 102 may be a smartphone with an integrated display. In another example, the electronic device 102 may be coupled to one or more remote displays 124 and/or to one or more remote devices that include one or more displays 124.

The communication interface 108 may enable the electronic device 102 to communicate with one or more other electronic devices (e.g., one or more peer devices 104). For example, the communication interface 108 may provide an interface for wired and/or wireless communications. In some configurations, the communication interface 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication. The communication interface 108 may be linked to one or more electronic devices (e.g., routers, modems, switches, servers, etc.). For example, the communication interface 108 may enable network (e.g., personal area network (PAN), local area network (LAN), metropolitan area network (MAN), wide area network (WAN), Internet, and/or public switched telephone network (PSTN), etc.) communications.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface). In some configurations, the communication interface 108 may send information (e.g., link initiation requests, peer device 104 available processing capacity requests, peer device 104 task capability requests, task instructions, offloading instructions, offloading requests, instructions to discontinue executing a task, etc.) to and/or receive information (e.g., link initiation communication, peer device 104 available processing capacity information, peer device 104 task capability information, task outputs, etc.) from another device (e.g., peer device 104, another electronic device, a computer, a remote server, etc.). The communication interface 108 may utilize one or more protocols (e.g., transmission control protocol (TCP), Internet protocol (IPv4, IPv6, etc.), hypertext transfer protocol (HTTP), etc.) for communication.

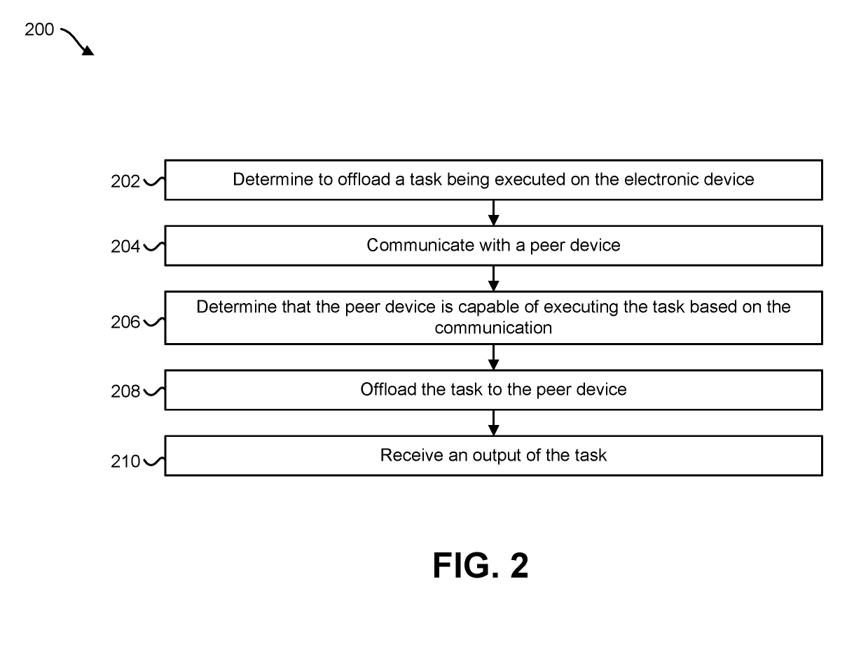

In some configurations, the electronic device 102 may perform one or more of the functions, procedures, methods, steps, etc., described in connection with one or more of FIGS. 2-10. Additionally or alternatively, the electronic device 102 may include one or more of the structures described in connection with one or more of FIGS. 2-10.

The processor 112 may include and/or implement an offloading controller 114. The offloading controller 114 may control offloading functionality of the electronic device 102. The offloading controller 114 may determine whether to offload one or more tasks 116 being executed on the electronic device 102. A task (e.g., task 116, task 118, etc.) may be one or more instructions. Examples of tasks include applications, modules, processes, software libraries, software routines and/or subroutines, executable code, etc. For instance, the processor 112 on the electronic device 102 may execute one or more tasks 116. More specific examples of tasks include a maps application, an image processing application (e.g., image enhancement, object detection, object recognition, etc.), a scheduling application, a calendaring application, a word processing application, a spreadsheet application, an email application, a messaging application, a browser application, a social media application, a news application, a game, a media (e.g., audio and/or video) player application, a photo viewing application, and/or one or more subroutines thereof, etc.

In some configurations, the offloading controller 114 may monitor a processing load of the electronic device 102 (e.g., processor 112) in order to determine whether to offload one or more tasks 116. A processing load (e.g., MIPS) detection mechanism may be utilized. For example, the electronic device 102 may maintain one or more hardware counters in registers (in a power management unit (PMU), for example). The offloading controller 114 (and/or another task) may monitor the registers to determine a processing load (e.g., CPU load). For instance, the registers may be monitored periodically (e.g., every 50 milliseconds (ms)) to determine the processing load. Accordingly, the offloading controller 114 may use the monitoring to continuously determine the processing load.

Additional or alternative approaches may be utilized in other configurations. For example, the offloading controller 114 may utilize a queue size of a task scheduler as a measurement of processing load (or a measurement that impacts processing load, for instance). Additionally or alternatively, the offloading controller 114 may query an operating system (OS) for a measurement of processing load (or a measurement that impacts processing load, for instance). Additionally or alternatively, the offloading controller 114 may utilize idle task behavior to determine processing load (or a measurement that impacts processing load, for instance). For example, a running average percentage of processor 106 usage may be a total number of processor cycles (e.g., instructions) in a period minus a number of processor cycles utilized for an idle task divided by the total number of cycles.

Accordingly, the offloading controller 114 may utilize a hardware register count (over a period of time, for example), task scheduler queue size, an OS measurement, idle task behavior, and/or a running average percentage of processor usage to calculate the processing load. For example, the hardware register count over a period of time, the OS measurement, or the running average percentage of processor usage (or a combination thereof) may be the processing load. In some implementations, the processing load may be determined in units of MIPS. For example, the offloading controller 114 may determine to offload a task by determining that the processing load in MIPS has exceeded a MIPS threshold.

In some configurations, the offloading controller 114 may determine whether to offload one or more tasks 116 based on comparing the processing load with a processing load threshold. For example, if the processing load exceeds a processing load threshold, the offloading controller 114 may determine to offload one or more tasks 116.

In some configurations, the offloading controller 114 may determine whether to offload one or more tasks 116 based on one or more conditions (in addition to or alternatively from processing load). For example, the offloading controller 114 may determine whether to offload one or more tasks 116 based on a thermal condition. In some configurations, the offloading controller 114 may obtain one or more thermal indicators (e.g., thermal measurements). For example, the electronic device 102 may include a temperature sensor for monitoring the temperature of the processor 112. If the thermal indicator (e.g., temperature) exceeds a thermal threshold, the offloading controller 114 may determine to offload one or more tasks 116.

The offloading controller 114 may communicate with one or more peer devices 104. For example, the offloading controller 114 may send one or more link initiation requests, peer device 104 available processing capacity requests, peer device 104 task capability requests, task instructions, offloading instructions, offloading requests, and/or instructions to discontinue executing a task, etc. Communicating with the one or more peer devices 104 may be accomplished via the communication interface(s) 108.

The electronic device 102 may communicate with one or peer devices 104 with one or more links 132. A link 132 may be a wired and/or wireless link. For example, the electronic device 102 may communicate with a peer device 104 by utilizing the communication interface(s) 108 and/or antenna(s) 110 to communicate with the peer device 104 over a wireless link 132. The link 132 may be a direct link, a network link (with or without one or more intervening devices (e.g., routers, switches), for example), an ad-hoc network link, a PAN link, a Bluetooth link, a cellular link, a LAN link, etc. It should be noted that the electronic device 102 and the peer device 104 may be separate devices in some configurations. For example, the electronic device 102 and the peer device(s) 104 may not be integrated into a single device.

The offloading controller 114 may receive information (e.g., data) from one or more peer devices 104 (via the communication interface 108, for example). For instance, the offloading controller 114 may receive link initiation communication, peer device 104 available processing capacity information, peer device 104 task capability information, and/or task outputs, etc., from one or more peer devices 104.

The offloading controller 114 may determine whether one or more peer device(s) 104 are capable of executing one or more of the tasks 116. Determining whether a peer device 104 is capable of executing one or more tasks 116 may be based on the communication between the offloading controller 114 and the peer device 104. For example, the offloading controller 114 may determine whether a peer device 104 is capable of executing one or more tasks 116 based on the peer device 104 available processing capacity information and/or peer device 104 task capability information.

The peer device 104 available processing capacity information may indicate a processing capacity of the peer device 104. For example, the peer device 104 available processing capacity information may indicate available processing capacity, available processing bandwidth, available unused processing capacity, MIPS, processor usage (e.g., percentage of processor usage), peer device 104 processing load, etc.

The offloading controller 114 may utilize the peer device 104 available processing capacity information to determine whether a peer device 104 is capable of executing one or more of the tasks 116. In some configurations, the offloading controller 114 may compare the processing capacity information with an amount of processing utilized to execute a task 116. If the processing capacity information indicates greater capacity (without or without some margin, for instance) than the amount of processing utilized to execute a task 116, the offloading controller 114 may determine that the peer device 104 is capable of executing the task 116. For example, if a task 116 utilizes approximately 500 MIPS and the peer device 104 processing capacity indicates that the peer device 104 has 2000 MIPS available, the offloading controller 114 may determine that the peer device 104 is capable of executing the task 116. Additionally or alternatively, the offloading controller 114 may compare the peer device 104 processing load with the electronic device 102 processing load to determine whether the peer device 104 is capable of executing one or more tasks 116. For example, if the peer device 104 processing load is lower than the electronic device 102 processing load, the offloading controller 114 may determine that the peer device 104 is capable of executing one or more tasks 116. Additionally or alternatively, the offloading controller 114 may compare the peer device 104 available processing capacity information to one or more thresholds. For example, if the peer device 104 processor usage is less than 80%, the offloading controller 114 may determine that the peer device 104 is capable of executing one or more tasks.

The offloading controller 114 may utilize the peer device 104 task capability information to determine whether a peer device 104 is capable of executing one or more of the tasks 116. For example, the peer device 104 task capability information may be used in addition to or alternatively from the peer device 104 available processing capacity information to determine whether a peer device 104 is capable of executing one or more of the tasks 116. Peer device 104 task capability information may indicate one or more tasks 118 (e.g., task instructions) available on the peer device 104. For example, the peer device 104 task capability information may indicate one or more installed tasks, one or more installed applications, etc. In some configurations, the offloading controller 114 may compare the peer device 104 task capability information with the one or more tasks 116. This may be performed to determine whether the peer device 104 has one or more of the same tasks 118 (e.g., applications) installed as the task(s) 116 on the electronic device 102. If the peer device 104 task capability information indicates one or more same tasks 118 (as the task(s) 116 being executed on the electronic device 102), the offloading controller 114 may determine that the peer device 104 is capable of executing the corresponding task(s) 116. For example, if the electronic device 102 is running a maps application and the peer device 104 has the same maps application installed, the offloading controller 114 may determine that the peer device 104 is capable of executing the maps application.

It should be noted that in some configurations, both criteria (e.g., peer device 104 available processing capacity and peer device 104 task capability) may be utilized to determine whether the peer device is capable of executing the task(s) 116. For example, if the same one or more tasks 118 are installed on the peer device 104 and the peer device 104 has enough available processing capacity, the offloading controller 114 may determine that the peer device 104 is capable of executing the one or more corresponding tasks 116.

In some configurations, if a peer device 104 does not have the task capability (e.g., does not have the task instructions, application instructions, etc., for execution, does not have the task or application installed, etc.), the electronic device 102 (e.g., offloading controller 114) may send information to enable the peer device 104 to execute the task (e.g., task instructions, application instructions, a network address to download task instructions (e.g., application instructions), instructions to install a task (e.g., application), etc.). This may enable the offloading controller 114 to offload one or more tasks 116 to the peer device 104 upon becoming capable to execute the one or more tasks 116.

The offloading controller 114 may offload one or more tasks 116 to one or more peer devices 104. For example, the offloading controller 114 may provide for a task to be executed by a peer device 104 in place of the electronic device 102. Offloading a task 116 may include sending an instruction to the peer device 104 to cause the peer device 104 to execute the task 118. Offloading a task 116 may include stopping execution of the task 116 on the electronic device 102. Offloading a task 116 may include sending data (e.g., one or more task inputs) to the peer device 104. It should be noted that a task may be a subroutine in some cases. For example, the electronic device 102 may continue to run an application while offloading one or more subroutines of the application. This may enable the application to continue to provide an output (e.g., an image, output data, etc.) and/or continue to provide a user interface for user interaction while another device performs other subroutines of the application.

The electronic device 102 (e.g., the offloading controller 114) may receive an output of the task 118 (e.g., the offloaded task). For example, the peer device 104 (e.g., one or more tasks 118 being executed on the peer device 104) may produce one or more outputs for one or more tasks 118 that have been offloaded from the electronic device 102. The output(s) may be produced while the peer device 104 is executing the task(s) 118. The peer device 104 may send the output(s) to the electronic device 102. The electronic device 102 (e.g., offloading controller 114) may receive the output(s) of the task(s). The electronic device 102 (e.g., processor 112, offloading controller 114, etc.) may utilize the output(s). For example, the electronic device 102 may store the output(s), may present the output(s) on the display(s) 124, may send the output(s) to one or more other devices, and/or may provide the output(s) to one or more tasks (e.g., applications) for further utilization and/or processing.

In some configurations, the offloading controller 114 may prioritize and/or order one or more tasks 116 for offloading. For example, the offloading controller 114 may prioritize offloading tasks 116 that require a larger amount of processing. Accordingly, tasks 116 that require more processing may be offloaded first, while tasks that require less processing may be offloaded last. In another example, tasks 116 that require a lesser amount of processing may be prioritized. In some configurations, the prioritization order of tasks 116 for offloading may be based on user settings. For example, the electronic device 102 may receive one or more user inputs that indicate a priority for task 116 offloading. Additionally or alternatively, one or more other criteria may be utilized. For example, tasks 116 that require less responsive speeds (e.g., social networking applications, email, etc.) may be prioritized, while tasks 116 that require more responsiveness (e.g., gaming applications) may be de-prioritized. In some cases, offloading a task 116 may add latency to the response time of a task.

In some approaches, offloading may be performed until one or more conditions are met. For example, offloading may be performed until processing load is reduced to a threshold amount, until a thermal condition is reduced to a threshold amount, etc. For instance, the electronic device 102 may offload a task 116 and determine if a processing load reduction threshold is met. If the processing load reduction threshold is not met (e.g., the processing load is still above the processing load reduction threshold), the electronic device 102 may offload another task 116 and so on, until the processing load reduction threshold is met.

In some configurations, the offloading controller 114 may determine, after one or more tasks 116 have been offloaded, to restore the task(s) 116 to the electronic device 102. For example, the electronic device 102 may determine to discontinue offloading the task 116 to the peer device 104. In some approaches, the offloading controller 114 may determine to restore one or more offloaded tasks 118 based on processing load.

In some configurations, the offloading controller 114 may monitor a processing load of the electronic device 102 (e.g., processor 112) in order to determine whether to restore one or more tasks 116. For example, the offloading controller 114 may utilize a hardware register count (over a period of time, for example), task scheduler queue size, an OS measurement, idle task behavior, and/or a running average percentage of processor usage to calculate the processing load as described above. If the processing load falls below a threshold (e.g., a restoration threshold), then the offloading controller 114 may determine to restore one or more tasks 116. For example, the offloading controller 114 may determine to restore a task by determining that the processing load in MIPS has fallen below a MIPS threshold. It should be noted that a threshold for determining to offload and a threshold for determining to restore may be the same value or different values. It may be beneficial to utilize different values to avoid rapidly switching between an offloading mode and a restoration or no offloading mode.

In some configurations, the offloading controller 114 may determine whether to restore one or more tasks 116 based on comparing the processing load with a restoration threshold. For example, if the processing load is less than or equal to a restoration threshold, the offloading controller 114 may determine to restore one or more tasks 116.

In some configurations, the offloading controller 114 may determine whether to restore one or more tasks 116 based on one or more conditions (in addition to or alternatively from processing load). For example, the offloading controller 114 may determine whether to restore one or more tasks 116 based on a thermal condition. If a thermal indicator (e.g., temperature) is less than or equal to a thermal restoration threshold, the offloading controller 114 may determine to restore one or more tasks 116.

As discussed above, the electronic device 102 may communicate with one or more peer devices 104 via one or more links 132 (e.g., wired and/or wireless links 132). In some configurations, the electronic device 102 may dynamically initiate a peer-to-peer link 132. For example, the electronic device 102 may determine to seek a peer-to-peer relationship with one or more peer devices 104 based on a processing load and/or other condition (e.g., thermal condition). In some approaches, the electronic device 102 (e.g., offloading controller 114) may determine to seek a peer relationship with one or more potential peer devices when the processing load (or other condition (e.g., thermal condition)) exceeds a threshold (e.g., a link initiation threshold). The threshold may be the same as or different from the threshold for determining to offload a task (e.g., an offloading threshold). For example, the offloading controller 114 may both determine to seek a peer-to-peer relationship and to offload a task 116 when a single threshold is exceeded. In another example, the offloading controller 114 may determine to seek a peer-to-peer relationship at a first (e.g., lower) threshold than determining to offload a task 116. This may allow the electronic device 102 to initiate one or more peer-to-peer relationships in order to prepare for offloading one or more tasks 116 in a case that a second (e.g., higher) threshold is reached (for processing load and/or thermal condition, etc., for example). In some configurations and/or cases, the electronic device 102 and the one or more peer devices 104 may not have a predetermined and/or static relationship (e.g., predetermined server-client relationship, master-slave relationship, peer relationship, etc.). Pairing may occur at runtime.

Initiating a peer-to-peer relationship with one or more peer devices 104 may include discovering one or more peer devices 104 and/or communicating with (e.g., requesting a peer-to-peer relationship with) one or more peer devices 104. For example, the electronic device 102 may discover a peer device 104 by scanning channels, listening for a beacon signal, sending a discover signal, receiving a response from one or more peer devices 104, etc. Communicating with one or more peer devices 104 to initiate a peer relationship may include sending a peer relationship request message, sending authentication information, receiving authentication information, and/or following a messaging protocol for establishing a peer-to-peer relationship.

It should be noted that a peer device 104 may be the same kind of device as the electronic device 102 or may be a different kind of device. For example, the electronic device 102 may be a smartphone and the peer device 104 may also be a smartphone. In another example, the electronic device 102 may be a smartphone and the peer device 104 may be a tablet device. The electronic device 102 and peer device(s) 104 may be other combinations. For example, the electronic device 102 and/or one or more peer devices 104 may be combinations of one or more smartphones, tablet devices, laptop computers, desktop computers, TVs, appliances, servers, game consoles, network devices, etc.

One or more peer devices 104 may include one or more communication interfaces 128, one or more processors 106, and memory 120. The processor 106 may be coupled to (e.g., in electronic communication with) the memory 120 and/or communication interface 128. The processor 106 may be a general-purpose single- or multi-chip microprocessor (e.g., an ARM), a special-purpose microprocessor (e.g., a digital signal processor (DSP)), a microcontroller, a programmable gate array, etc. The processor 106 may be referred to as a central processing unit (CPU). Although just a single processor 106 is shown in the peer device 104, in an alternative configuration, a combination of processors (e.g., an ISP and an application processor, an ARM and a DSP, etc.) could be used. The processor 106 may be configured to implement one or more of the functions, procedures, and/or methods disclosed herein.

The memory 120 may store instructions for performing operations by the processor 106. The memory 120 may be any electronic component capable of storing electronic information. The memory 120 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data and/or instructions may be stored in the memory 120. The instructions may be executable by the processor 106 to implement one or more of the methods described herein. Executing the instructions may involve the use of the data that is stored in the memory 120. When the processor 106 executes the instructions, various portions of the instructions may be loaded onto the processor 106, and various pieces of data may be loaded onto the processor 106.

The processor 106 may access (e.g., read from and/or write to) the memory 120. Examples of instructions and/or data that may be stored by the memory 120 may include one or more task inputs, offloading manager 130 instructions, and/or task 118 instructions, etc. In some configurations, the peer device 104 may include and/or be coupled to one or more displays.

The communication interface 128 may enable the peer device 104 to communicate with one or more other electronic devices (e.g., electronic device 102). For example, the communication interface 128 may provide an interface for wired and/or wireless communications. In some configurations, the communication interface 128 may be coupled to one or more antennas for transmitting and/or receiving radio frequency (RF) signals. Additionally or alternatively, the communication interface 128 may enable one or more kinds of wireline (e.g., Universal Serial Bus (USB), Ethernet, etc.) communication. The communication interface 128 may be linked to one or more electronic devices (e.g., routers, modems, switches, servers, etc.). For example, the communication interface 128 may enable network (e.g., personal area network (PAN), local area network (LAN), metropolitan area network (MAN), wide area network (WAN), Internet, and/or public switched telephone network (PSTN), etc.) communications.

In some configurations, multiple communication interfaces 128 may be implemented and/or utilized. For example, one communication interface 128 may be a cellular (e.g., 3G, Long Term Evolution (LTE), CDMA, etc.) communication interface 128, another communication interface 128 may be an Ethernet interface, another communication interface 128 may be a universal serial bus (USB) interface, and yet another communication interface 128 may be a wireless local area network (WLAN) interface (e.g., Institute of Electrical and Electronics Engineers (IEEE) 802.11 interface). In some configurations, the communication interface 128 may send information (e.g., link initiation communication (e.g., response), peer device 104 available processing capacity information, peer device 104 task capability information, task outputs, etc.) to and/or receive information (e.g., link initiation requests, peer device 104 available processing capacity requests, peer device 104 task capability requests, task instructions, offloading instructions, offloading requests, instructions to discontinue executing a task, etc.) from another device (e.g., electronic device 102). The communication interface 128 may utilize one or more protocols (e.g., transmission control protocol (TCP), Internet protocol (IPv4, IPv6, etc.), hypertext transfer protocol (HTTP), etc.) for communication.

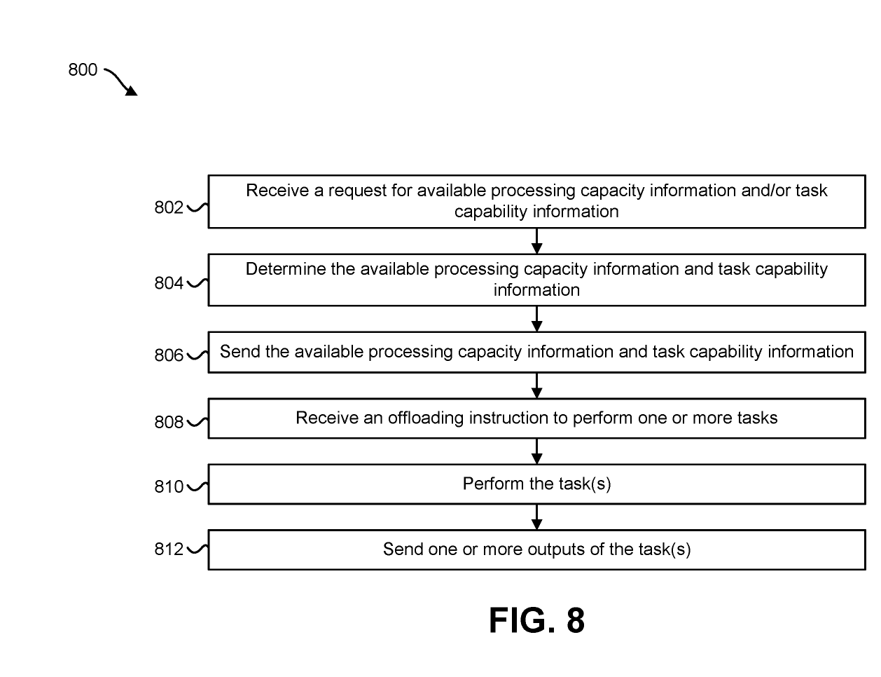

In some configurations, the peer device 104 may perform one or more of the functions, procedures, methods, steps, etc., described in connection with one or more of FIGS. 8-10. Additionally or alternatively, the peer device 104 may include one or more of the structures described in connection with one or more of FIGS. 8-10.

The processor 106 may include and/or implement an offloading manager 130. The offloading manager 130 may manage offloading functionality of the peer device 104. For example, the offloading manager 130 may manage requests for processing capacity information, requests for task capability information, received offloading instructions, performing one or more offloaded tasks 118, and/or sending output(s) of the offloaded task(s) 118.

The offloading manager 130 may communicate with the electronic device 102. For example, the offloading manager 130 may receive one or more link initiation requests, peer device 104 available processing capacity requests, peer device 104 task capability requests, task instructions, offloading instructions, offloading requests, and/or instructions to discontinue executing a task, etc. Communicating with the electronic device 102 may be accomplished via the communication interface(s) 128.

When receiving a link initiation request from the electronic device 102, the peer device 104 (e.g., communication interface 128, offloading manager 130, etc.) may accept the link initiation request (e.g., send a link acceptance, establish the link 132 (e.g., select a channel and/or protocol for the link 132), etc.). The offloading manager 130 may authenticate the electronic device 102 in some configurations. For example, the offloading manager 130 may request credentials and/or verify credentials before establishing the link 132.

The offloading manager 130 may receive a request for available processing capacity information from the electronic device 102. The offloading manager 130 may determine the peer device 104 available processing capacity information. The peer device 104 available processing capacity information may indicate available processing capacity, available processing bandwidth, available unused processing capacity, MIPS, processor usage (e.g., percentage of processor usage), peer device 104 processing load, etc. The peer device 104 (e.g., offloading manager 130) may send the peer device 104 available processing capacity information to the electronic device 102.

In some configurations, the offloading manager 130 may monitor a processing load of the peer device 104 (e.g., processor 106) in order to determine peer device 104 available processing capacity information. One or more approaches (based on hardware counters in registers, queue size of a task scheduler, OS query, idle task behavior, running average percentage of processor 106 usage, etc.) as described above may be utilized by the offloading manager 130 to determine a processing load. The processing load may be the peer device 104 available processing capacity information in some examples. For instance, a MIPS measurement of the processing load on the peer device 104 may be the peer device 104 available processing capacity information.

In addition to or alternatively from the peer device 104 available processing capacity information, the offloading manager 130 may receive a request for task capability information from the electronic device 102. The offloading manager 130 may determine the peer device 104 task capability information. For example, the offloading manager 130 may determine one or more installed tasks (e.g., tasks, applications, processes, routines, etc.) that the peer device 104 may execute. In some configurations, the peer device 104 may maintain a record (e.g., database, list, etc.) of one or more installed tasks. The offloading manager 130 may send a message indicating the one or more installed tasks to the electronic device 102 as the peer device 104 task capability information.

In another example, the request for task capability information may include a message that indicates one or more tasks for potential offloading. The offloading manager 130 may determine whether the peer device 104 has installed one or more of the task(s) for potential offloading. The offloading manager 130 may send an indicator of which of the task(s) for potential offloading (if any) is installed on the peer device 104 as the peer device 104 task capability information. This may indicate any matching tasks that the electronic device 102 may potentially offload with any installed task(s) on the peer device. In some configurations, peer device 104 available processing capacity information and peer device 104 task capability information may be sent together or separately. In some configurations, only one of peer device 104 available processing capacity information and peer device 104 task capability information may be sent.

In some configurations, if a peer device 104 does not have the task capability (e.g., does not have the task instructions, application instructions, etc., for execution, does not have the task or application installed, etc.), the peer device 104 (e.g., offloading manager 130) may receive information to enable the peer device 104 to execute the task (e.g., task instructions, application instructions, a network address to download task instructions (e.g., application instructions), instructions to install a task (e.g., application), etc.). The offloading manager 130 may receive the information (e.g., task instructions, application instructions, a network address to download task instructions (e.g., application instructions), instructions to install a task (e.g., application), etc.), which may be utilized to enable the peer device 104 to perform one or more offloaded tasks.

The peer device 104 (e.g., offloading manager 130) may receive an offloading instruction to perform one or more tasks 118. The offloading instruction may indicate one or more tasks 118 and/or may include a command to perform one or more tasks 118. In some configurations, the peer device 104 (e.g., offloading manager 130) may receive task input (from the electronic device 102 or another source, such as a remote server) to perform the task. For example, the offloading manager 130 may receive an offloading instruction to execute an image processing application. The offloading manager 130 may also receive image data for executing the image processing application.

The peer device 104 (e.g., offloading manager 130) may perform the one or more offloaded tasks 118. While performing the task(s) 118, the peer device 104 may generate one or more task outputs. For example, the peer device 104 may generate a processed image using an offloaded image processing application.

The peer device 104 (e.g., offloading manager 130) may send one or more outputs of the task(s) 118. For example, the offloading manager 130 may send (via the communication interface(s) 128 and/or the link 132, for instance) one or more task 118 outputs to the electronic device 102.

In some configurations and/or cases, the offloading manager 130 may receive an instruction to stop executing one or more offloaded tasks 118. The peer device 104 may then stop executing the one or more offloaded tasks 118. In some configurations and/or cases, the offloading manager 130 may determine that the peer device 104 is no longer capable of executing one or more offloaded tasks 118. For example, the offloading manager 130 may determine that one or more higher priority tasks 118 (e.g., local tasks) may not allow continuing to perform one or more offloaded tasks 118. The peer device 104 may discontinue performing the offloaded task(s) 118. The offloading manager 130 may send a notification to the electronic device 102 that the peer device 104 will no longer perform one or more offloaded tasks 118.

In an alternative approach, the offloading manager 130 may make a determination about whether the peer device 104 capable of performing one or more offloaded tasks 118 (which may be instead of or in addition to a determination by the offloading controller 114 on the electronic device 102 that a peer device is capable of performing one or more offloaded tasks, for example). For example, the offloading manager 130 may monitor the peer device 104 processing load and/or one or more other conditions (e.g., thermal conditions) and determine whether the peer device 104 is capable of performing one or more offloaded tasks 118. For example, if the peer device 104 processing load is below a threshold (and/or a peer device 104 thermal condition is below a threshold), the offloading manager 130 may determine that the peer device 104 is capable of performing one or more offloaded tasks. Additionally or alternatively, the offloading manager 130 may determine that the peer device 104 is capable of performing one or more tasks based on whether the task (e.g., task, application, process, routine, subroutine, etc.) is installed on the peer device 104. The offloading manager 130 may then send a message to the electronic device 102 to indicate which offloaded task(s) 118 the peer device 104 may perform.

In some configurations, one or more offloaded tasks may be continued to be executed until one or more conditions are met. For example, one or more offloaded tasks may be executed until a task is completed (e.g., until no task processing remains, until a task is closed, etc.) or until a command is received to end the task, etc. For instance, if the electronic device 102 receives an input (e.g., user input, communicated input, etc.) to terminate an offloaded task (e.g., application, etc.), the electronic device 102 may send an instruction to the peer device 104 to stop executing the task. The peer device 104 may stop executing the task upon receiving the instruction.

It should be noted that one or more of the approaches described herein may be performed with multiples tasks and/or multiple peer devices 104. For example, a peer device 104 may perform multiple offloaded tasks. Additionally or alternatively, the electronic device 102 may offload one or more tasks to multiple peer devices 104.

It should be noted that one or more of the elements or components of the electronic device may be combined and/or divided. For example, one or more of the offloading controller 114 and/or the task 116 may be divided into elements or components (e.g., subroutines, instruction subsets, etc.) that perform a subset of the operations thereof.

FIG. 2 is a flow diagram illustrating one configuration of a method 200 for managing processing load. The method 200 may be performed by one or more of the electronic devices described herein (e.g., the electronic device 102 described in connection with FIG. 1). The electronic device 102 may determine 202 to offload a task being executed on the electronic device 102. This may be accomplished as described in connection with FIG. 1. For example, the electronic device 102 may determine that a processing load has exceeded a threshold, that a thermal condition has exceeded a threshold, that a size of a task scheduler queue has exceeded a threshold, etc.

The electronic device 102 may communicate 204 with a peer device 104. This may be accomplished as described in connection with FIG. 1. For example, the electronic device 102 may send one or more peer device 104 available processing capacity requests, peer device 104 task capability requests, etc. Additionally or alternatively, the electronic device 102 may receive peer device 104 available processing capacity information, peer device 104 task capability information, etc.

The electronic device 102 may determine 206 that the peer device 104 is capable of executing the task based on the communication. This may be accomplished as described in connection with FIG. 1. For example, the electronic device 102 may determine whether a peer device 104 is capable of executing one or more tasks based on the peer device 104 available processing capacity information and/or peer device 104 task capability information. For instance, a peer device 104 may be capable of executing one or more tasks if the peer device 104 has enough processing capacity and/or has task capability (e.g., installed instructions of the one or more tasks).

The electronic device 102 may offload 208 the task to the peer device 104. This may be accomplished as described in connection with FIG. 1. For example, the electronic device 102 may send an instruction to the peer device 104 to cause the peer device 104 to execute the task, may stop execution of the task 116 on the electronic device 102, and/or may send data (e.g., one or more task inputs) to the peer device 104.

The electronic device 102 may receive 210 an output of the task. This may be accomplished as described in connection with FIG. 1. For example, the electronic device 102 may receive one or more task outputs of one or more offloaded tasks from one or more peer devices 104.

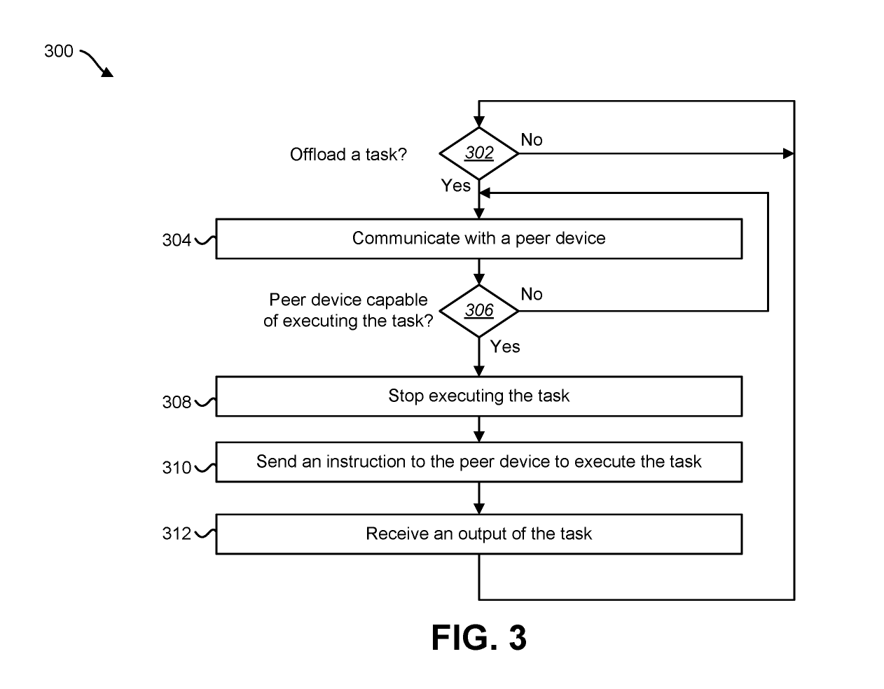

FIG. 3 is a flow diagram illustrating a more specific configuration of a method 300 for managing processing load. The method 300 may be performed by one or more of the electronic devices described herein (e.g., the electronic device 102 described in connection with FIG. 1). The electronic device 102 may determine 302 whether to offload a task being executed on the electronic device 102. This may be accomplished as described in connection with one or more of FIGS. 1-2. For example, the electronic device 102 may determine whether a processing load has exceeded a threshold, whether a thermal condition has exceeded a threshold, whether a size of a task scheduler queue has exceeded a threshold, etc. As illustrated in FIG. 3, if it is determined not to offload a task, the electronic device 102 may continue to operate without offloading a task until it is determined 302 to offload a task.

If the electronic device 102 determines to offload a task, the electronic device 102 may communicate 304 with a peer device 104. This may be accomplished as described in connection with one or more of FIGS. 1-2. For example, the electronic device 102 may send one or more peer device 104 available processing capacity requests, peer device 104 task capability requests, etc. Additionally or alternatively, the electronic device 102 may receive peer device 104 available processing capacity information, peer device 104 task capability information, etc.

The electronic device 102 may determine 306 whether the peer device 104 is capable of executing the task based on the communication. This may be accomplished as described in connection with one or more of FIGS. 1-2. For example, the electronic device 102 may determine whether a peer device 104 is capable of executing one or more tasks based on the peer device 104 available processing capacity information and/or peer device 104 task capability information. If the electronic device 102 determines 306 that a peer device 104 is not capable of executing the task, the electronic device 102 may continue to (attempt to) communicate with one or more peer devices 104 that may be capable of executing the task until a capable peer device 104 is communicated with. For example, a peer device 104 that was not capable initially may become capable (by reducing processor load and/or receiving task instructions, etc.). In another example, one or more other peer devices 104 may be discovered and/or contacted that may be capable of executing the task. In some configurations, attempting to communicate with one or more peer devices 104 may be discontinued (after an amount of time, after a number of attempts, etc.).

If the electronic device 102 determines 306 that a peer device is capable of executing the task, the electronic device 102 may stop 308 executing the task. This may be accomplished as described in connection with one or more of FIGS. 1-2. For example, the electronic device 102 may pause, suspend, terminate, and/or close a task being executed on the electronic device 102.

The electronic device 102 may send 310 an instruction to the peer device 104 to cause the peer device 104 to execute the task. This may be accomplished as described in connection with one or more of FIGS. 1-2. For example, the electronic device 102 may send a message (e.g., command) instructing the peer device 104 to execute the task. In some configurations, the instruction may identify the task to be executed. The electronic device 102 may optionally send data (e.g., one or more task inputs) to the peer device 104. The data may include data that the task is applied to, user input data, etc. In some configurations, the electronic device 102 may instruct the peer device 104 to get task input data from a source (e.g., a different source), such as a website, network storage location, etc.

The electronic device 102 may receive 312 an output of the task. This may be accomplished as described in connection with one or more of FIGS. 1-2. For example, the electronic device 102 may receive one or more task outputs of one or more offloaded tasks from one or more peer devices 104. In some configurations, one or more tasks (e.g., applications) running on the electronic device 102 may utilize the task output(s). In some configurations, the electronic device 102 may return to determining 302 whether to offload a task. For example, the electronic device 102 may continually (e.g., repeatedly) monitor processing load and/or thermal condition, etc., to determine 302 whether to offload one or more additional tasks, etc. In some approaches, offloading may be performed until one or more conditions are met. For example, offloading may be performed until processing load is reduced to a threshold amount, until a thermal condition is reduced to a threshold amount, until a task is completed (e.g., until no task processing remains, until the task is closed, etc.), etc.

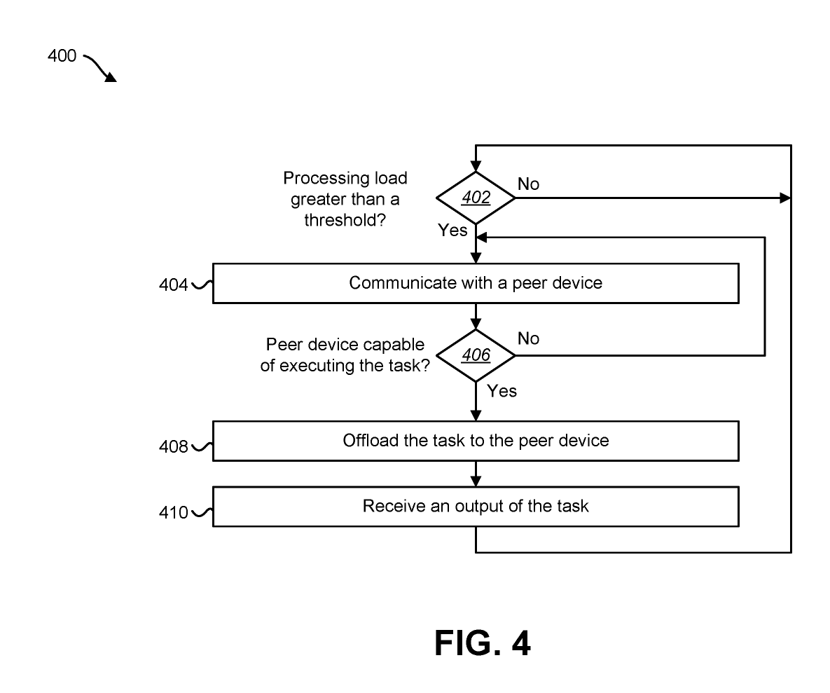

FIG. 4 is a flow diagram illustrating another more specific configuration of a method 400 for managing processing load. The method 400 may be performed by one or more of the electronic devices described herein (e.g., the electronic device 102 described in connection with FIG. 1).

The electronic device 102 may determine 402 whether a processing load is greater than a threshold (which may indicate whether to offload a task, for instance). This may be accomplished as described in connection with one or more of FIGS. 1-3. For example, the electronic device 102 may determine whether a processing load in MIPS has exceeded a processing load threshold in MIPS. In some configurations, the processing load threshold may be lower than the total processing capacity of the electronic device 102. For instance, assume that the electronic device 102 has a total processing capacity of 25,000 MIPS and that the processing load threshold is 20,000 MIPS. If the processing load of the electronic device 102 exceeds 20,000 MIPS in this example, the electronic device 102 may determine 402 that the processing load is greater than a threshold (to offload one or more tasks, for instance). Additionally or alternatively, the electronic device 102 may determine whether a thermal condition (e.g., temperature) is greater than a threshold. For example, if a processor temperature exceeds 55° Celsius (C.) (131° Fahrenheit (F.)), the electronic device 102 may determine that the thermal condition is greater than a threshold (to offload one or more tasks, for instance). As illustrated in FIG. 4, if it is determined that the processing load is not greater than a threshold, the electronic device 102 may continue to operate until it is determined 402 that the processing load is greater than a threshold.

If the electronic device 102 determines that the processing load is greater than a threshold (and/or that a thermal condition is greater than a threshold), the electronic device 102 may communicate 404 with a peer device 104. This may be accomplished as described in connection with one or more of FIGS. 1-3.

The electronic device 102 may determine 406 whether the peer device 104 is capable of executing the task based on the communication. This may be accomplished as described in connection with one or more of FIGS. 1-3. If the electronic device 102 determines 406 that a peer device 104 is not capable of executing the task, the electronic device 102 may continue to (attempt to) communicate with one or more peer devices 104 that may be capable of executing the task until a capable peer device 104 is communicated with.

If the electronic device 102 determines 406 that a peer device is capable of executing the task, the electronic device 102 may offload 408 the task. This may be accomplished as described in connection with one or more of FIGS. 1-3.

The electronic device 102 may receive 410 an output of the task. This may be accomplished as described in connection with one or more of FIGS. 1-3. In some configurations, the electronic device 102 may return to determining 402 whether the processing load is greater than a threshold (and/or whether a threshold condition is greater than a threshold). For example, the electronic device 102 may continually (e.g., repeatedly) monitor processing load and/or thermal condition, etc., to determine 402 whether to offload one or more additional tasks, etc.

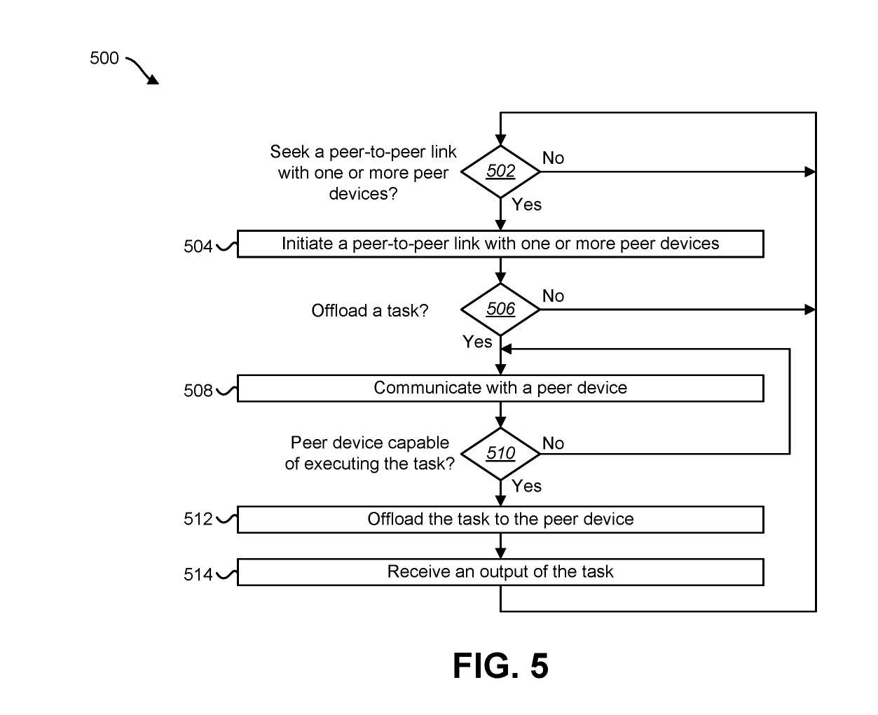

FIG. 5 is a flow diagram illustrating yet another more specific configuration of a method 500 for managing processing load. The method 500 may be performed by one or more of the electronic devices described herein (e.g., the electronic device 102 described in connection with FIG. 1).

The electronic device 102 may determine 502 whether to seek a peer-to-peer link with one or more peer devices. For example, the electronic device 102 may determine 502 whether to seek one or more peer-to-peer links with one or more peer devices in order to potentially offload one or more tasks. In some configurations, determining 502 whether to seek a peer-to-peer link may be based on a processing load, a thermal condition, and/or one or more other conditions. The determination 502 may be based on a first threshold (e.g., a link initiation threshold). For example, the electronic device 102 may determine 502 to seek a peer-to-peer link if a processing load is greater than a link initiation threshold. In some approaches, the first threshold (e.g., link initiation threshold) may be lower than a second threshold for offloading a task (e.g., an offloading threshold). For example, a link initiation threshold may be 18,000 MIPS and an offloading threshold may be 20,000 MIPS (or 52° C. and 55° C. for a thermal condition, for instance). Accordingly, the electronic device 102 may determine 502 to seek one or more peer links in anticipation of potentially offloading one or more tasks. In other configurations, an electronic device 102 may determine 502 to seek one or more peer-to-peer links by default or upon detecting the presence of one or more potential peer-to-peer devices (e.g., receiving a beacon signal, receiving a response to a discovery signal, etc.). As illustrated in FIG. 5, if it is determined 502 to not seek a peer-to-peer link, the electronic device 102 may continue to operate until it is determined 502 to seek a peer-to-peer link.

If it is determined 502 to seek a peer-to-peer link, the electronic device 102 may initiate 504 a peer-to-peer link with one or more peer devices 104. For example, the electronic device 102 may send one or more link initiation requests to one or more peer devices. One or more peer devices 104 may accept the link initiation request(s). Accordingly, the electronic device 102 may establish a peer-to-peer link with one or more peer devices 104.

The electronic device 102 may determine 506 whether to offload a task being executed on the electronic device 102. This may be accomplished as described in connection with one or more of FIGS. 1-4.

If the electronic device 102 determines 506 to offload a task, the electronic device 102 may communicate 508 with a peer device 104. This may be accomplished as described in connection with one or more of FIGS. 1-4.

The electronic device 102 may determine 510 whether the peer device 104 is capable of executing the task based on the communication. This may be accomplished as described in connection with one or more of FIGS. 1-4. If the electronic device 102 determines 510 that a peer device 104 is not capable of executing the task, the electronic device 102 may continue to (attempt to) communicate with one or more peer devices 104 that may be capable of executing the task until a capable peer device 104 is communicated with.

If the electronic device 102 determines 510 that a peer device 104 is capable of executing the task, the electronic device 102 may offload 512 the task to the peer device 104. This may be accomplished as described in connection with one or more of FIGS. 1-4.

The electronic device 102 may receive 514 an output of the task. This may be accomplished as described in connection with one or more of FIGS. 1-4. In some configurations, the electronic device 102 may return to determining 502 whether to seek a peer-to-peer link and/or to determining 506 whether to offload a task (to one or more peer devices 104 with which a link has been established, for example). For example, the electronic device 102 may continually (e.g., repeatedly) monitor processing load and/or thermal condition, etc., to determine 502 whether to seek a peer-to-peer link and/or to determine 506 whether to offload one or more additional tasks, etc.

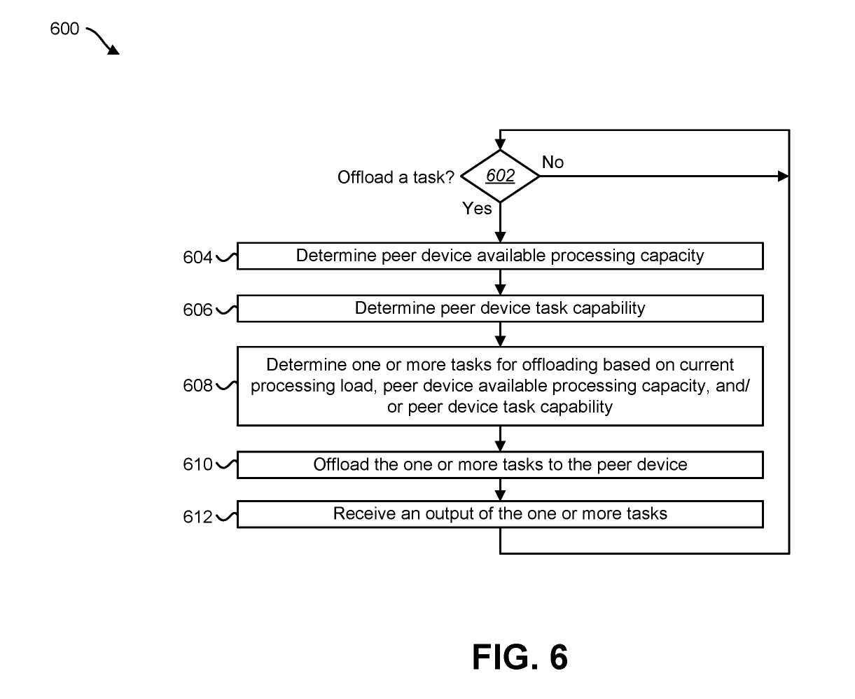

FIG. 6 is a flow diagram illustrating yet another more specific configuration of a method 600 for managing processing load. The method 600 may be performed by one or more of the electronic devices described herein (e.g., the electronic device 102 described in connection with FIG. 1).

The electronic device 102 may determine 602 whether to offload a task being executed on the electronic device 102. This may be accomplished as described in connection with one or more of FIGS. 1-5. As illustrated in FIG. 6, if it is determined not to offload a task, the electronic device 102 may continue to operate without offloading a task until it is determined 602 to offload a task.

If the electronic device 102 determines to offload a task, the electronic device 102 may determine 604 peer device 104 available processing capacity. This may be accomplished as described in connection with one or more of FIGS. 1-5. For example, the electronic device 102 may send one or more peer device 104 available processing capacity requests. The electronic device 102 may receive peer device 104 available processing capacity information. The peer device 104 processing capacity information may indicate available processing capacity, available processing bandwidth, available unused processing capacity, MIPS, processor usage (e.g., percentage of processor usage), peer device 104 processing load, etc.

The electronic device 102 may determine 606 peer device 104 task capability. This may be accomplished as described in connection with one or more of FIGS. 1-5. For example, the electronic device 102 may send one or more peer device 104 task capability requests. In some configurations, the peer device 104 available processing capacity request and the peer device 104 task capability request may be the same message. Alternatively, the peer device 104 available processing capacity request and the peer device 104 task capability request may be separate messages. The electronic device 102 may receive peer device 104 task capability information (together with or separate from available processing capacity information, for instance). The peer device 104 task capability information may indicate one or more tasks (e.g., task instructions) available on the peer device 104. For example, the peer device 104 task capability information may indicate one or more installed tasks, one or more installed applications, etc.

The electronic device 102 may determine 608 one or more tasks for offloading based on current processing load, available peer device 104 processing capacity, and/or peer device 104 task capability. This may be accomplished as described in connection with one or more of FIGS. 1-5. For example, the electronic device 102 may determine whether one or more of the peer devices 104 may execute one or more of the tasks that the electronic device 102 is currently running. For instance, the electronic device 102 may compare the task(s) currently running on the electronic device 102 with task(s) that are installed on one or more peer devices 104 as indicated by the peer device 104 task capability information. The electronic device 102 may select (e.g., choose, narrow down a set of tasks, etc.) one or more tasks currently running on the electronic device 102 that may be executed by one or more peer devices 104.

Additionally or alternatively, the determination 608 may be based on the peer device 104 available processing capacity information. For example, the electronic device 102 may compare the amount of processing (e.g., processing load) utilized for executing one or more tasks with the peer device 104 available processing capacity. For instance, if the electronic device 102 is running a task that requires an amount of processing (e.g., 1,000 MIPS), but a peer device 104 has less processing capacity available (e.g., only has 800 MIPS of available processing capacity), the electronic device 102 may not select that task for offloading to that peer device 104. If the electronic device 102 is running a task that requires an amount of processing (e.g., 1,000 MIPS) and a peer device 104 has the amount or a greater amount of processing capacity available (e.g., only has 1,200 MIPS of available processing capacity), the electronic device 102 may select that task for offloading to that peer device 104. Accordingly, the electronic device 102 may determine 608 one or more tasks for offloading, where one or more peer devices have a capability and/or sufficient processing capacity to perform the task(s).

The electronic device 102 may offload 610 the one or more (determined) tasks to one or more peer devices 104. This may be accomplished as described in connection with one or more of FIGS. 1-5.

The electronic device 102 may receive 612 an output of the one or more tasks. This may be accomplished as described in connection with one or more of FIGS. 1-5. In some configurations, the electronic device 102 may return to determining 602 whether to offload a task.

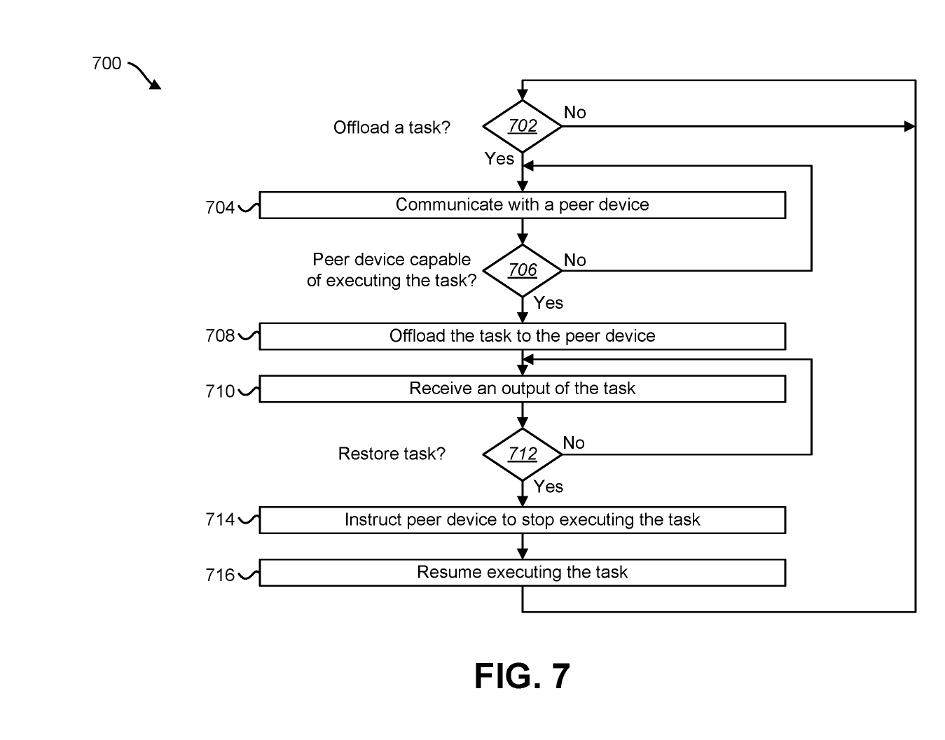

FIG. 7 is a flow diagram illustrating yet another more specific configuration of a method 700 for managing processing load. The method 700 may be performed by one or more of the electronic devices described herein (e.g., the electronic device 102 described in connection with FIG. 1).

The electronic device 102 may determine 702 whether to offload a task. This may be accomplished as described in connection with one or more of FIGS. 1-6. As illustrated in FIG. 7, if it is determined not to offload a task, the electronic device 102 may continue to operate without offloading a task until it is determined 702 to offload a task.

If the electronic device 102 determines 702 to offload a task, the electronic device 102 may communicate 704 with a peer device 104. This may be accomplished as described in connection with one or more of FIGS. 1-6.

The electronic device 102 may determine 706 whether the peer device 104 is capable of executing the task based on the communication. This may be accomplished as described in connection with one or more of FIGS. 1-6. If the electronic device 102 determines 706 that a peer device 104 is not capable of executing the task, the electronic device 102 may continue to (attempt to) communicate with one or more peer devices 104 that may be capable of executing the task until a capable peer device 104 is communicated with.

If the electronic device 102 determines 706 that a peer device is capable of executing the task, the electronic device 102 may offload 708 the task to the peer device. This may be accomplished as described in connection with one or more of FIGS. 1-6.

The electronic device 102 may receive 710 an output of the task. This may be accomplished as described in connection with one or more of FIGS. 1-6.

The electronic device 102 may determine 712 whether to restore one or more tasks. This may be accomplished as described in connection with FIG. 1. In some configurations, determining 712 whether to restore a task may be based on a processing load. For example, if a processing load on the electronic device 102 falls below a threshold (e.g., a restoration threshold), the electronic device 102 may determine 712 to restore a task. If the processing load on the electronic device 102 does not fall below the threshold, the electronic device 102 may determine 712 to not restore the task. If the electronic device 102 determines 712 not to restore the task, the electronic device 102 may continue receiving 710 output of one or more offloaded tasks.

In some configurations, the restoration threshold may be lower than the offloading threshold. This may prevent rapidly switching between determining to offload a task and then determining to restore the task, since offloading a task may reduce the processing load to below the offloading threshold in some cases.

In some configurations, the electronic device 102 may determine 712 whether to restore a task based on one or more addition criteria. For example, the electronic device 102 may determine whether restoring a task would increase the processing load to exceed an offloading threshold (based on the amount of processing utilized to execute the task). If restoring the task would increase the processing load to exceed the offloading threshold, the electronic device 102 may determine 712 not to restore the task.

If the electronic device 102 determines 712 to restore a task (e.g., one or more tasks), the electronic device 102 may instruct 714 one or more peer devices to stop executing one or more tasks. For example, the electronic device 102 may send an instruction to one or more peer devices 104 to stop executing the task(s). The electronic device 102 may resume 716 executing the task. For example, the electronic device 102 may restart one or more tasks and/or release a suspension on one or more tasks. In some configurations, the electronic device 102 may update the state of the task(s) based on the received output(s) from the one or more peer devices 104.

In some configurations, the electronic device 102 may return to determining 702 whether to offload one or more tasks. For example, the electronic device 102 may continually (e.g., repeatedly) monitor processing load and/or thermal condition, etc., to determine 702 whether to re-offload one or more tasks, to offload one or more additional tasks, etc.

FIG. 8 is a flow diagram illustrating one configuration of a method 800 for performing (e.g., executing) one or more offloaded tasks. The method 800 may be performed by one or more of peer devices described herein (e.g., the peer device(s) 104 described in connection with FIG. 1).

The peer device 104 may receive 802 a request for available processing capacity information and/or task capability information. This may be accomplished as described in connection with FIG. 1. For example, the peer device 104 may receive one or more messages (via a wired and/or wireless link, for instance) indicating a request for peer device 104 available processing capacity information and/or task capability information.

The peer device 104 may determine 804 the available processing capacity information and/or the task capability information. This may be accomplished as described in connection with FIG. 1. For example, the peer device 104 may determine a current processing load (e.g., MIPS and/or other information indicating processing capacity such as a queue size of a task scheduler, OS measurement of processing load, idle task behavior, etc.). Additionally or alternatively, the peer device 104 may determine peer device 104 task capability information. For example, the peer device 104 may determine a set (e.g., list) of installed tasks and/or tasks that the peer device 104 may execute (e.g., installed tasks).

The peer device 104 may send 806 the available processing capacity information and/or the task capability information to the electronic device 102. This may be accomplished as described in connection with FIG. 1. For example, the peer device 104 may send the available processing capacity information and/or the task capability information to the electronic device 102 in one or more messages over one or more links.

The peer device 104 may receive 808 an offloading instruction to perform one or more tasks. This may be accomplished as described in connection with FIG. 1. For example, the peer device 104 may receive one or more messages from the electronic device 102 over a link that instructs the peer device 104 to perform one or more tasks. The message(s) may identify which task(s) to perform (e.g., execute).

The peer device 104 may perform 810 the one or more tasks. This may be accomplished as described in connection with FIG. 1. For example, the peer device 104 may execute one or more offloaded tasks (instead of the electronic device 102). In some configurations, the peer device 104 may receive task input data. For example, the peer device 104 may receive task input data from the electronic device 102 and/or may request and/or receive task input data from one or more other devices (e.g., remote devices, networked devices, web servers, etc.).

The peer device 104 may send 812 one or more outputs of the task(s). This may be accomplished as described in connection with FIG. 1. For example, the peer device 104 may produce one or more task outputs from one or more tasks as the task(s) are being performed (e.g., executed). The peer device 104 may send 812 the one or more outputs of the task(s) to the electronic device 102 in one or more messages (via a link, for example).

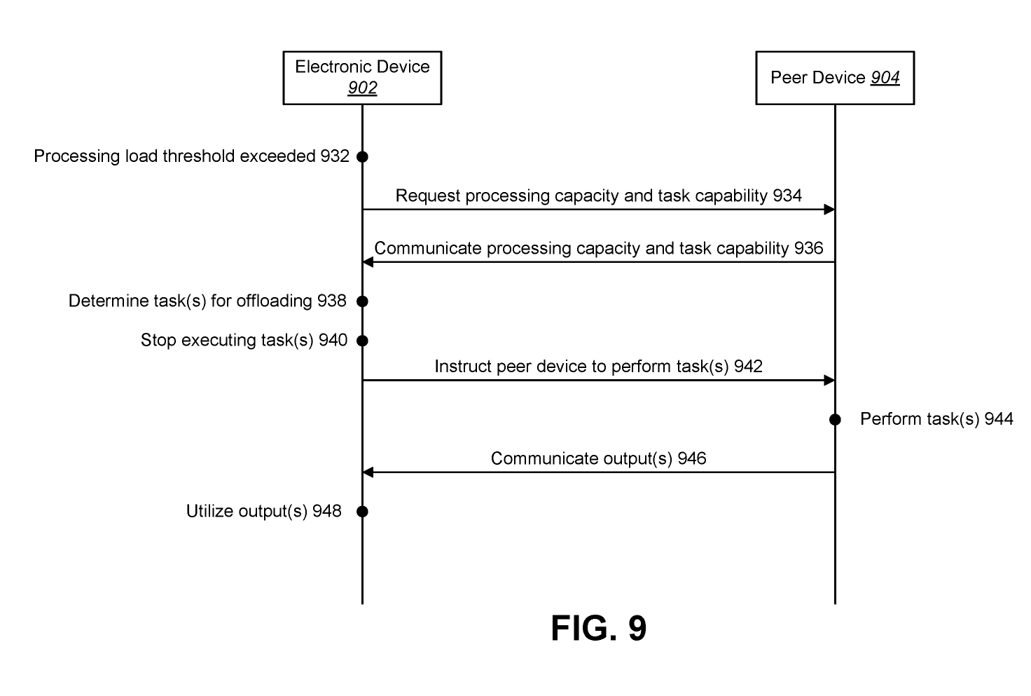

FIG. 9 is a thread diagram illustrating an example of offloading one or more tasks to a peer device 904 in accordance with the systems and methods disclosed herein. In particular, FIG. 9 illustrates an electronic device 902 and a peer device 904. The electronic device 102 may be an example of the electronic device 102 described in connection with FIG. 1 and the peer device 904 may be an example of the peer device 104 described in connection with FIG. 1. FIG. 9 illustrates some functions or procedures that may be carried out in accordance with some configurations of the systems and methods disclosed herein.

The electronic device 902 may determine 932 that a processing load threshold has been exceeded. This may be accomplished as described in connection with one or more of FIGS. 1-7.

The electronic device 902 may request 934 processing capacity information and/or task capability information. This may be accomplished as described in connection with one or more of FIGS. 1-7.

The peer device 904 may communicate 936 the processing capacity information and/or task capability information to the electronic device 902. This may be accomplished as described in connection with one or more of FIGS. 1-7.

The electronic device 902 may determine 938 one or more tasks for offloading. This may be accomplished as described in connection with one or more of FIGS. 1 and 6.

The electronic device 902 may stop 940 executing the task(s). This may be accomplished as described in connection with one or more of FIGS. 1-7.

The electronic device 902 may instruct 942 the peer device 104 to perform the task(s). This may be accomplished as described in connection with one or more of FIGS. 1-7.

The peer device 904 may perform 944 (e.g., execute) the task(s). This may be accomplished as described in connection with one or more of FIGS. 1 and 8.

The peer device 904 may communicate 946 one or more task outputs to the electronic device 902. This may be accomplished as described in connection with one or more of FIGS. 1-8.

The electronic device 902 may utilize 948 the task output(s). This may be accomplished as described in connection with one or more of FIGS. 1 and 3. For example, the electronic device 902 may present a task output on a display, may store the task output, may provide the task output to one or more other tasks (e.g., applications), may send the task output to another device, etc.

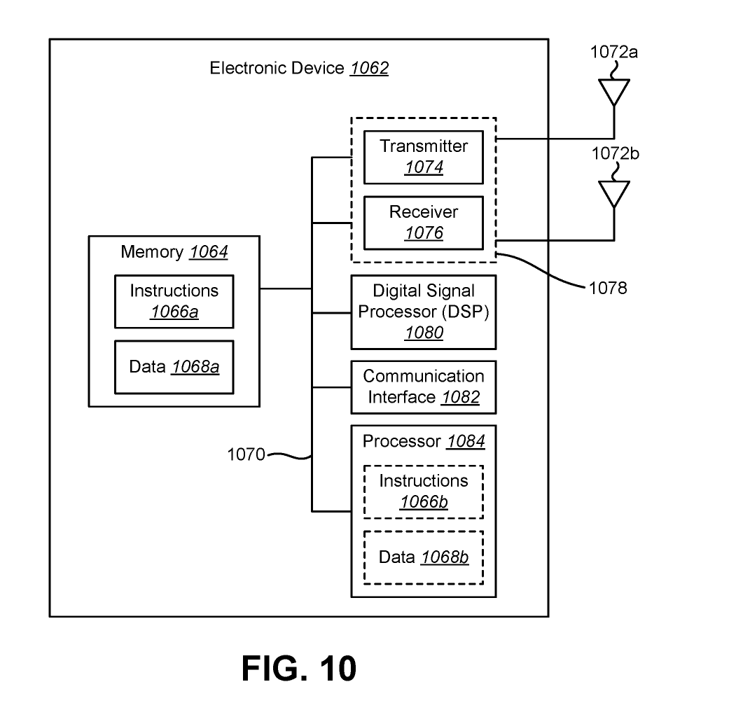

FIG. 10 illustrates certain components that may be included within an electronic device 1062 configured to implement various configurations of the systems and methods disclosed herein. Examples of the electronic device 1062 may include cellular phones, smart phones, computers (e.g., desktop computers, laptop computers, servers, etc.), tablet devices, media players, televisions, vehicles, automobiles, cameras, virtual reality devices (e.g., headsets), augmented reality devices (e.g., headsets), mixed reality devices (e.g., headsets), aircraft, healthcare equipment, gaming consoles, personal digital assistants (PDAs), set-top boxes, appliances, etc. The electronic device 1062 may be implemented in accordance with the electronic device 102 and/or the peer device 104 described in connection with FIG. 1.

The electronic device 1062 includes a processor 1084. The processor 1084 may be a general purpose single- or multi-chip microprocessor (e.g., an ARM), a special purpose microprocessor (e.g., a digital signal processor (DSP)), a microcontroller, a programmable gate array, etc. The processor 1084 may be referred to as a central processing unit (CPU). Although just a single processor 1084 is shown in the electronic device 1062, in an alternative configuration, a combination of processors (e.g., an ARM and DSP) could be implemented.

The electronic device 1062 also includes memory 1064. The memory 1064 may be any electronic component capable of storing electronic information. The memory 1064 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 1068a and instructions 1066a may be stored in the memory 1064. The instructions 1066a may be executable by the processor 1084 to implement one or more of the methods, procedures, steps, and/or functions described herein. Executing the instructions 1066a may involve the use of the data 1068a that is stored in the memory 1064. When the processor 1084 executes the instructions 1066, various portions of the instructions 1066b may be loaded onto the processor 1084 and/or various pieces of data 1068b may be loaded onto the processor 1084.

The electronic device 1062 may also include a transmitter 1074 and a receiver 1076 to allow transmission and reception of signals to and from the electronic device 1062. The transmitter 1074 and receiver 1076 may be collectively referred to as a transceiver 1078. One or more antennas 1072a-b may be electrically coupled to the transceiver 1078. The electronic device 1062 may also include (not shown) multiple transmitters, multiple receivers, multiple transceivers and/or additional antennas.

The electronic device 1062 may include a digital signal processor (DSP) 1080. The electronic device 1062 may also include a communication interface 1082. The communication interface 1082 may allow and/or enable one or more kinds of input and/or output. For example, the communication interface 1082 may include one or more ports and/or communication devices for linking other devices to the electronic device 1062. In some configurations, the communication interface 1082 may include the transmitter 1074, the receiver 1076, or both (e.g., the transceiver 1078). Additionally or alternatively, the communication interface 1082 may include one or more other interfaces (e.g., touchscreen, keypad, keyboard, microphone, camera, etc.). For example, the communication interface 1082 may enable a user to interact with the electronic device 1062.

The various components of the electronic device 1062 may be coupled together by one or more buses, which may include a power bus, a control signal bus, a status signal bus, a data bus, etc. For the sake of clarity, the various buses are illustrated in FIG. 10 as a bus system 1070.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes, and variations may be made in the arrangement, operation, and details of the systems, methods, and apparatus described herein without departing from the scope of the claims.

What is claimed is:

1. A method for managing processing load by an electronic device, comprising:
determining to offload a task being executed on the electronic device;
communicating with a peer device;
determining that the peer device is capable of executing the task based on the communication;
offloading the task to the peer device; and
receiving an output of the task, wherein the output is generated while the peer device is executing the task.

2. The method of claim 1, wherein offloading the task comprises stopping execution of the task on the electronic device.

3. The method of claim 1, wherein offloading the task comprises sending an instruction to the peer device to cause the peer device to execute the task.

4. The method of claim 1, wherein determining to offload the task comprises determining that the processing load of the electronic device has exceeded a threshold.

5. The method of claim 4, wherein determining to offload the task comprises determining that the processing load in Million Instructions Per Second (MIPS) has exceeded a MIPS threshold.

6. The method of claim 1, wherein determining to offload the task is based on a thermal condition on the electronic device.

7. The method of claim 1, wherein determining that the peer device is capable of executing the task comprises determining that the peer device has available processing capacity to execute the task.

8. The method of claim 1, further comprising:
determining, after the task has been offloaded, to restore the task to the electronic device;
instructing the peer device to stop executing the task; and
resuming executing the task on the electronic device.

9. The method of claim 1, further comprising utilizing, by one or more applications on the electronic device, the output of the task.

10. The method of claim 1, further comprising dynamically initiating a peer-to-peer link with the peer device in response to determining to seek the peer-to-peer relationship with one or more potential peer devices based on the processing load.

11. An electronic device for managing processing load, comprising:
a processor configured to:
determine to offload a task being executed on the electronic device;
communicate with a peer device;
determine that the peer device is capable of executing the task based on the communication;
offload the task to the peer device; and
receive an output of the task, wherein the output is generated while the peer device is executing the task.

12. The electronic device of claim 11, wherein the processor is configured to stop execution of the task on the electronic device.

13. The electronic device of claim 11, wherein the processor is configured to send an instruction to the peer device to cause the peer device to execute the task.

14. The electronic device of claim 11, wherein the processor is configured to determine to offload the task based on determining that the processing load of the electronic device has exceeded a threshold.

15. The electronic device of claim 14, wherein the processor is configured to determine to offload the task based on determining that the processing load in Million Instructions Per Second (MIPS) has exceeded a MIPS threshold.

16. The electronic device of claim 11, wherein the processor is configured to determine to offload the task based on a thermal condition on the electronic device.

17. The electronic device of claim 11, wherein the processor is configured to determine that the peer device is capable of executing the task based on determining that the peer device has available processing capacity to execute the task.

18. The electronic device of claim 11, wherein the processor is configured to:
determine, after the task has been offloaded, to restore the task to the electronic device;
instruct the peer device to stop executing the task; and
resume executing the task on the electronic device.

19. The electronic device of claim 11, wherein the processor is configured to utilize, by one or more applications on the electronic device, the output of the task.

20. The electronic device of claim 11, wherein the processor is configured to dynamically initiate a peer-to-peer link with the peer device in response to determining to seek the peer-to-peer relationship with one or more potential peer devices based on the processing load.

21. A computer-program product for managing processing load, comprising a non-transitory tangible computer-readable medium having instructions thereon, the instructions comprising:
code for causing an electronic device to determine to offload a task being executed on the electronic device;
code for causing the electronic device to communicate with a peer device;
code for causing the electronic device to determine that the peer device is capable of executing the task based on the communication;
code for causing the electronic device to offload the task to the peer device; and
code for causing the electronic device to receive an output of the task, wherein the output is generated while the peer device is executing the task.

22. The computer-program product of claim 21, wherein the code for causing the electronic device to offload the task comprises code for causing the electronic device to stop execution of the task on the electronic device.

23. The computer-program product of claim 21, wherein the code for causing the electronic device to offload the task comprises code for causing the electronic device to send an instruction to the peer device to cause the peer device to execute the task.

24. The computer-program product of claim 21, wherein the code for causing the electronic device to determine to offload the task comprises code for causing the electronic device to determine that the processing load of the electronic device has exceeded a threshold.

25. The computer-program product of claim 21, wherein the code for causing the electronic device to determine that the peer device is capable of executing the task comprises code for causing the electronic device to determine that the peer device has available processing capacity to execute the task.

26. An apparatus for managing processing load, comprising:
means for determining to offload a task being executed on the electronic device;
means for communicating with a peer device;
means for determining that the peer device is capable of executing the task based on the communication;
means for offloading the task to the peer device; and
means for receiving an output of the task, wherein the output is generated while the peer device is executing the task.

27. The apparatus of claim 26, wherein the means for offloading the task comprises means for stopping execution of the task on the electronic device.

28. The apparatus of claim 26, wherein the means for offloading the task comprises means for sending an instruction to the peer device to cause the peer device to execute the task.

29. The apparatus of claim 26, wherein the means for determining to offload the task comprises means for determining that the processing load of the electronic device has exceeded a threshold.

30. The apparatus of claim 26, wherein the means for determining that the peer device is capable of executing the task comprises means for determining that the peer device has available processing capacity to execute the task.
